(19) United States
(12) Patent Application Publication
(10) Pub. No.: US 2026/0244674 A1
(43) Pub. Date: Aug. 20, 2026

(54) TEACHING DATA CORRECTION DEVICE

(71) Applicant: NTT DOCOMO, INC., Tokyo (JP)

(72) Inventors: Ayaka OORUI, Tokyo (JP); Hiroshi FUJIMOTO, Tokyo (JP); Yutaro SHIRAMIZU, Tokyo (JP)

(73) Assignee: NTT DOCOMO, INC., Tokyo (JP)

(21) Appl. No.: 19/160,638

(22) PCT Filed: Apr. 4, 2024
(86) PCT No.: PCT/JP2024/013984

§ 371 Date: Aug. 28, 2025

(30) Foreign Application Priority Data
Apr. 20, 2023 (JP) 2023-069331

(51) Int. Cl. G06F 16/35; G06F 16/31

(52) U.S. Cl. CPC G06F 16/35; G06F 16/322

(57) ABSTRACT

A training data correction device (1) includes a deletion data decision unit (15) configured to acquire category information indicating a first category, which is one category, and a second category, which is a category having a hierarchical relationship with the first category and to which a document included in training data that should belong to the first category erroneously belongs or is likely to erroneously belong and identify a feature term in a document that is included in the training data and that belongs to the first category indicated in the acquired category information, and a training data deletion unit (16) configured to delete, from the training data, a set of documents including the identified term among documents included in the training data and belonging to a second category indicated in the acquired category information.

### TECHNICAL FIELD

An aspect of the present disclosure relates to a training data correction device for correcting training data.

### BACKGROUND ART

In the following Patent Literature 1, a correction method in which incorrectly labeled training data is a correction work target is disclosed.

### CITATION LIST

### Patent Literature

Patent Literature 1: Japanese Unexamined Patent Publication No. 2022-021858

### SUMMARY OF INVENTION

### Technical Problem

The labels in the above-described correction method include OK labels attached to image data of normal products and NG labels attached to image data of abnormal products. Therefore, in the above-described correction method, for example, it is not possible to correct training data including sets of categories with a hierarchical structure and documents belonging to the categories.

### Solution to Problem

According to an aspect of the present disclosure, there is provided a training data correction device for correcting training data including sets of categories with a hierarchical structure and documents belonging to the categories, the training data correction device comprising: an acquisition unit configured to acquire category information indicating a first category, which is one category, and a second category, which is a category having a hierarchical relationship with the first category and to which a document included in training data that should belong to the first category erroneously belongs or is likely to erroneously belong; and a deletion unit configured to identify a feature term in a document that is included in the training data and that belongs to the first category indicated in the category information acquired by the acquisition unit and delete, from the training data, a set of documents including the identified term among documents included in the training data and belonging to the second category indicated in the acquired category information.

In this aspect, the training data includes sets of categories with a hierarchical structure and documents belonging to the categories and a set of documents including a feature term in the documents belonging to the first category among documents belonging to the second category (which is a category in a hierarchical relationship with the first category) included in the training data is deleted from the training data. In other words, it is possible to correct training data including sets of categories with a hierarchical structure and documents belonging to the categories.

### Advantageous Effects of Invention

According to an aspect of the present disclosure, it is possible to correct training data including sets of categories with a hierarchical structure and documents belonging to the categories.

### BRIEF DESCRIPTION OF DRAWINGS

FIG. 1 A diagram showing an example of a functional configuration of a training data correction device according to an embodiment.

FIG. 2 A diagram showing an example of a system of categories with a hierarchical structure.

FIG. 3 A diagram showing a scene in which the system example in FIG. 2 has been changed.

FIG. 4 A diagram showing an example of misclassification of a document classification model trained on the basis of incorrect training data of the system example.

FIG. 5 A flowchart showing an example of a process executed by the training data correction device according to the embodiment.

FIG. 6 A diagram showing an example of a table of the training data.

FIG. 7 A diagram showing an example of a table of upper-lower category pair data.

FIG. 8 A diagram showing an example of a table of table data in which the category classification results are horizontally combined with the training data.

FIG. 9 A diagram showing an example of a table of upper-lower category pair data with a correction-required flag.

FIG. 10 A diagram showing an example of a table of data representing feature words and feature quantities of lower categories.

FIG. 11 A diagram showing an example of deletion of training data.

FIG. 12 A flowchart showing an example of a process executed by a machine learning unit 11 and an inference unit 12.

FIG. 13 A diagram showing an example of another table of training data.

FIG. 14 A diagram showing an example of a table of training data.

FIG. 15 A diagram showing an example of a table of evaluation data.

FIG. 16 A diagram showing an example of a table of category classification results.

FIG. 17 A diagram showing an example of another table of table data in which the category classification results are horizontally combined with the training data.

FIG. 18 A flowchart showing an example of a process executed by a misclassification rate calculation unit 13 and a training data correction determination unit 14.

FIG. 19 An example of records extracted from the table example in FIG. 17.

FIG. 20 A diagram showing an example of a table in which a misclassification rate column is added to the table example of FIG. 7.

FIG. 21 A flowchart showing an example of a process executed by a deletion data decision unit 15 and a training data deletion unit 16.

FIG. 22 A diagram showing an example of a table of morphologically analyzed table data.

FIG. 23 A diagram showing an example of classification of the table example of FIG. 22.

FIG. 24 An example of a table of data in which all morphological analysis columns of the table extracted from the table example in FIG. 23 are combined.

FIG. 25 A diagram showing an example of a table of a feature quantity table.

FIG. 26 A diagram showing an example of another table of data representing feature words and feature quantities of lower categories.

FIG. 27 A diagram showing an example of deletion of an upper category table.

FIG. 28 A flowchart showing another example of the process executed by the training data correction device according to the embodiment.

FIG. 29 A diagram showing an example of a hardware configuration of a computer used in a training data correction device according to the embodiment.

### DESCRIPTION OF EMBODIMENTS

Hereinafter, embodiments of the present invention will be described in detail with reference to the drawings. In the description of the drawings, the same reference signs are used for the same elements and redundant description thereof will be omitted. Moreover, the embodiments in the present disclosure in the following description are specific examples of the present invention and the present invention is not limited to these embodiments unless otherwise specified.

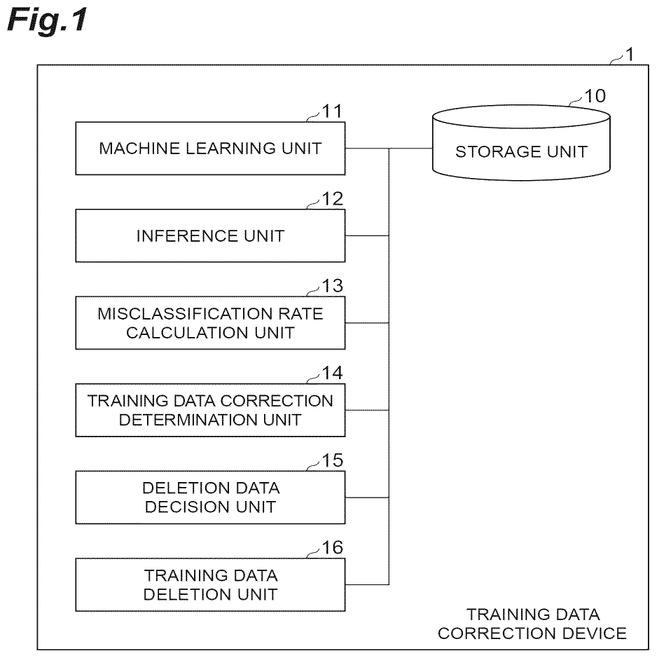

FIG. 1 is a diagram showing an example of a functional configuration of a training data correction device 1 according to an embodiment. As shown in FIG. 1, the training data correction device 1 includes a storage unit 10, a machine learning unit 11 (a learning unit), an inference unit 12 (a learning unit), a misclassification rate calculation unit 13, a training data correction determination unit 14, a deletion data decision unit 15 (an acquisition unit and a deletion unit) and a training data deletion unit 16 (an acquisition unit and a deletion unit).

Although each functional block of the training data correction device 1 is assumed to function within the training data correction device 1, the present disclosure is not limited thereto. For example, some of the functional blocks of the training data correction device 1 may be a computer device different from the training data correction device 1 and may perform a function of appropriately transmitting and receiving information to and from the training data correction device 1 within a computer device having a network connection with the training data correction device 1. Moreover, some functional blocks of the training data correction device 1 may be eliminated, a plurality of functional blocks may be combined into one functional block, or one functional block may be decomposed into a plurality of functional blocks.

The training data correction device 1 corrects training data including sets of categories with a hierarchical structure and documents belonging to the categories. The hierarchical structure of the categories may change over time.

The categories will be described. As a background, in category classification with a hierarchical structure, new categories may be extracted as necessary, and added and deleted as lower categories. For example, in the case of the news article site targeted by the embodiment, it is possible to make it easier for more users to find the necessary content in the website by adding a new category of high-profile topics.

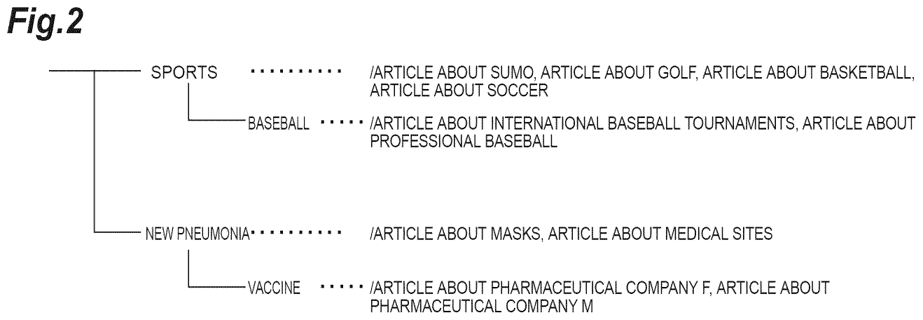

FIG. 2 is a diagram showing an example of a system of categories with a hierarchical structure. In the system example shown in FIG. 2, the categories include sports, baseball, new pneumonia, and vaccines. The categories have a hierarchical structure. For example, the sports category is an upper category higher than the baseball category, and conversely, the baseball category is lower than the sports category. Likewise, the new pneumonia category is an upper category higher than the vaccine category, and conversely, the vaccine category is lower than the new pneumonia category.

Each category is associated with (includes) documents belonging to the category. Specifically, the sports category is linked to articles about sumo, golf, basketball, and soccer. The baseball category is linked to articles about international baseball tournaments and professional baseball. The new pneumonia category is linked to articles about masks and medical sites. The vaccine category is linked to articles about pharmaceutical company F and pharmaceutical company M.

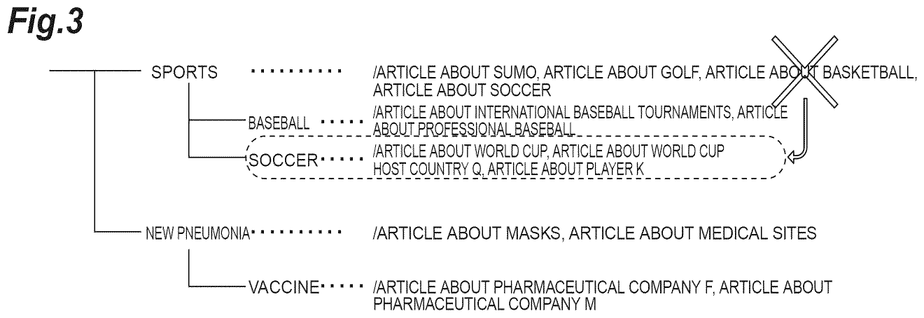

FIG. 3 is a diagram showing a scene in which the system example in FIG. 2 has been changed. FIG. 3 shows a scene where a new soccer category was added (extracted) because the World Cup soccer tournament was held and articles about soccer were attracting more attention over time. Soccer articles that are linked to the sports category before the soccer category is added will be removed (unlinked) from the sports category and moved (linked) to the added soccer category. Specifically, articles about the World Cup, World Cup host country Q, and player K as articles about the soccer will be moved to the added soccer category. Thus, a soccer category is added during the World Cup season and deleted from the category when the trend subsides.

The issues in the above-described categories will be described. When machine learning is used to automatically classify articles by category, a mixture of data with different historical category systems can lead to misclassification. In the machine learning, normally, because more data can create a more accurate model, data should be kept except in the case where changes have been made. It is necessary to reduce misclassification by removing only those areas that have changed (e.g., soccer-related articles) from the past training data.

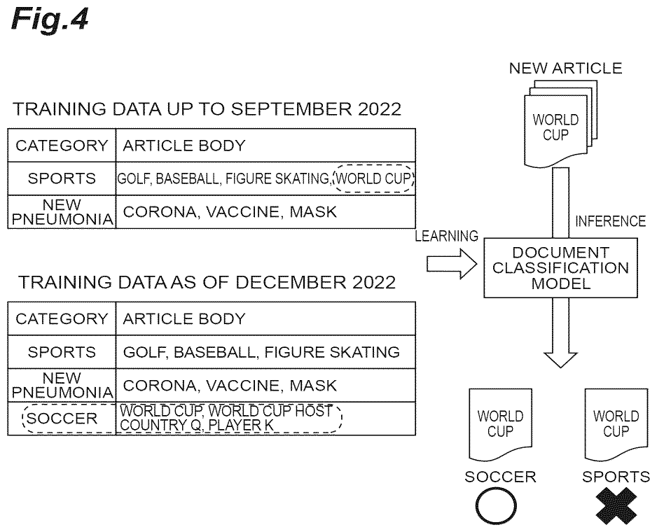

FIG. 4 is a diagram showing an example of misclassification of a document classification model trained on the basis of incorrect training data of the system example. The training data up to September 2022 (past training data) and as of December 2022 (current training data) shown in FIG. 4 are training data including sets of categories with a hierarchical structure and documents belonging to the categories.

In the past training data, World Cup articles are linked to the sports category. In the current training data, World Cup articles have been removed from the sports category and linked to the newly added soccer category. Here, if a new article about the World Cup is inferred using a document classification model that is trained on the basis of past training data and automatically classifies articles by category, the article will be classified as the sports category, which is a misclassification. On the other hand, when a new World Cup article is inferred using a document classification model trained on the basis of current training data, it will be correctly classified as the soccer category.

The training data correction device 1 can efficiently and easily correct and format past training data when the category system changes.

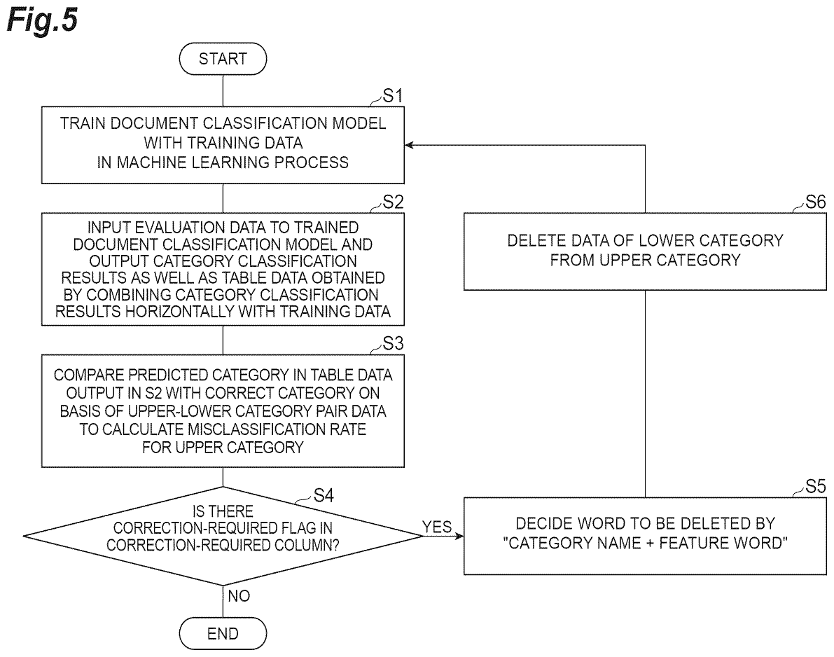

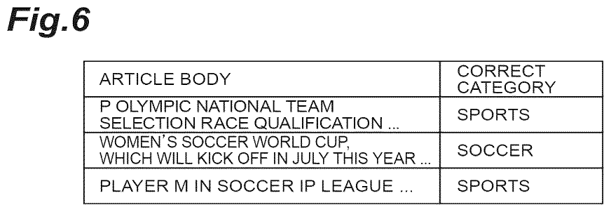

Hereinafter, each function of the training data correction device 1 shown in FIG. 1 will be described using a flowchart shown in FIG. 5, table examples shown in FIGS. 6 to 11, and the like. FIG. 5 is a flowchart showing an example of a process executed by the training data correction device 1.

The storage unit 10 stores training data including sets of categories with a hierarchical structure and documents belonging to the categories. FIG. 6 is a diagram showing an example of a table of the training data. In the table example shown in FIG. 6, an article body, which is a document, corresponds to (a name of) a correct category, which is the category to which the article body belongs. A correct category may be a category that has been manually assigned by a person by looking at the content of the article body in advance. In the table example shown in FIG. 6, the correct category for the article body about soccer, “player M in the IP league of soccer . . . ” is “sports” (correctly “soccer”), but removing this is the goal (of the flowchart shown in FIG. 5).

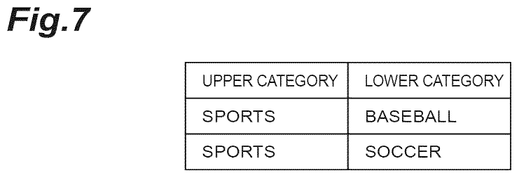

The storage unit 10 stores upper-lower category pair data, which is data of pairs of upper and lower categories. FIG. 7 is a diagram showing an example of a table of upper-lower category pair data. In the table example shown in FIG. 7, (a category name of) the upper category and (a category name of) the lower category are associated.

In addition, the storage unit 10 stores any information (including various types of data described in the embodiment) used in calculations and the like in the training data correction device 1 and the like and results of calculations in the training data correction device 1. The information stored by the storage unit 10 may be referred to by each function of the training data correction device 1 as appropriate.

The machine learning unit 11 trains the document classification model with the training data stored by the storage unit 10 in a machine learning process (step S1). A document classification model is a model that classifies the category to which any input document belongs.

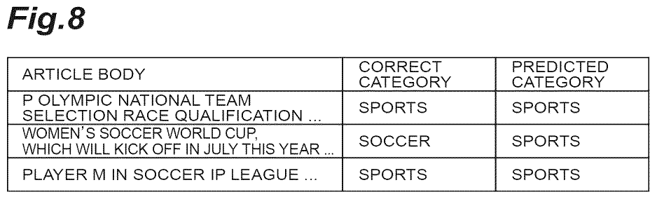

After S1, the inference unit 12 inputs evaluation data (e.g., the article body of the table example of training data shown in FIG. 6) to the trained document classification model and outputs category classification results as well as the table data obtained by horizontally combining the category classification results with the training data (step S2). FIG. 8 is a diagram showing an example of a table of table data in which the category classification results are horizontally combined with the training data. In the table example shown in FIG. 8, the article body (in the training data table example shown in FIG. 6), the correct category (in the training data table example shown in FIG. 6), and the category classification result described above are associated.

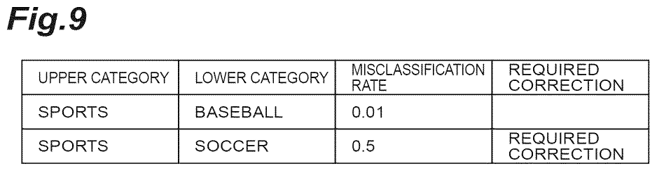

After S2, the misclassification rate calculation unit 13 compares a predicted category in the table data output in S2 with a correct category on the basis of the upper-lower category pair data stored by the storage unit 10 to calculate the misclassification rate (to be described below) for the upper category (step S3). FIG. 9 is a diagram showing an example of a table of upper-lower category pair data with a correction-required flag (to be described below). In the table example shown in FIG. 9, the upper category (of the table example of the upper-lower category pair data shown in FIG. 7) and the lower category (of the table example of the upper-lower category pair data shown in FIG. 7), the above-described misclassification rate, and the above-described correction-required flag are associated.

After S3, the training data correction determination unit 14 determines whether or not there is a correction-required flag in a correction-required column (of the upper-lower category pair data with the correction-required flag) (step S4). When it is determined that there is no correction-required flag in S4 (S4: NO), the process ends.

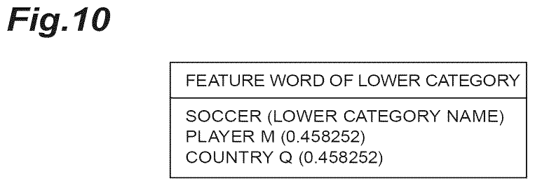

When it is determined that there is a correction-required flag in S4 (S4: YES), the deletion data decision unit 15 decides a word to be deleted by “category name+feature word” (step S5). FIG. 10 is a diagram showing an example of a table of data representing feature words and feature quantities of lower categories. The table example shown in FIG. 10 includes a name indicating a lower category, a feature word (to be described below), and a feature word for the lower category consisting of the feature word and the feature quantity of the feature word.

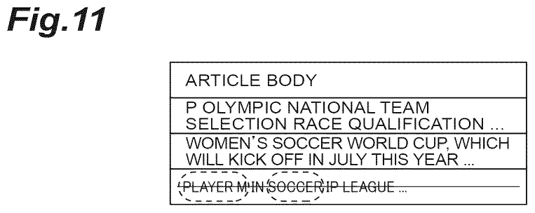

After S5, the training data deletion unit 16 deletes data of the lower category from the upper category (step S6). FIG. 11 is a diagram showing an example of deletion of training data. The deletion example shown in FIG. 11 shows that the article body of the table example of training data shown in FIG. 6, which includes words included in the table example of data representing feature words and feature quantities of the lower categories shown in FIG. 10, has been deleted.

After S6, the process returns to S1 and is iterated.

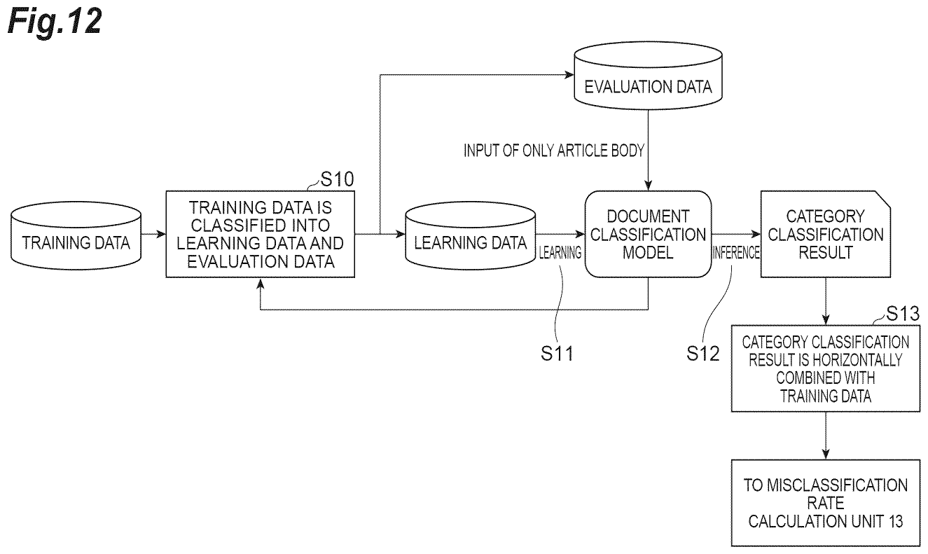

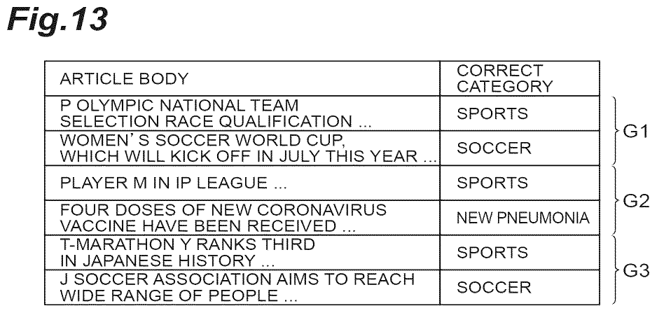

Hereinafter, details of the machine learning unit 11 and the inference unit 12 will be described using the flowchart shown in FIG. 12 and the table examples shown in FIGS. 13 to 17. FIG. 12 is a flowchart showing an example of a process executed by the machine learning unit 11 and the inference unit 12.

The machine learning unit 11 classifies the previously acquired training data (stored by the storage unit 10) into K (K is an integer greater than or equal to 2) groups (step S10). FIG. 13 is a diagram showing an example of another table of training data. In the table example shown in FIG. 13, the training data (having the same configuration as the training data table example shown in FIG. 6) is classified into three (K=3) groups, i.e., a group G1 (including first and second records of the training data), a group G2 (including third and fourth records of the training data) and a group G3 (including fifth and sixth records of the training data).

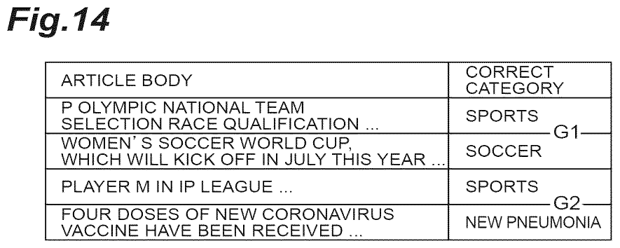

After S10, the machine learning unit 11 trains a document classification model using data of (K−1) groups (learning data) (step S11). For example, the machine learning unit 11 learns with data of the groups G1 and G2. FIG. 14 is a diagram showing an example of a table of training data. The table example shown in FIG. 14 shows the data for the groups G1 and G2 of the table example of the training data shown in FIG. 13.

The machine learning unit 11 iteratively learns with respect to S11 K times to obtain K document classification models. For example, the machine learning unit 11 obtains three document classification models, i.e., document classification model 1 trained with data from the groups G1 and G2, document classification model 2 trained with data from the groups G1 and G3, and document classification model 3 trained with data from the groups G2 and G3.

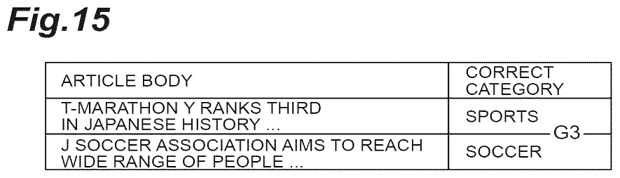

After S11, the inference unit 12 performs inference using training data (evaluation data) that is not used in training for all document classification models (step S12). For example, the inference unit 12 infers with data from the group G3 for document classification model 1, infers with data from the group G2 for document classification model 2, and infers with data from the group G1 for document classification model 3. FIG. 15 is a diagram showing an example of a table of evaluation data. The table example in FIG. 15 shows the data for the group G3 (evaluation data for document classification model 1) in the training data table example shown in FIG. 13.

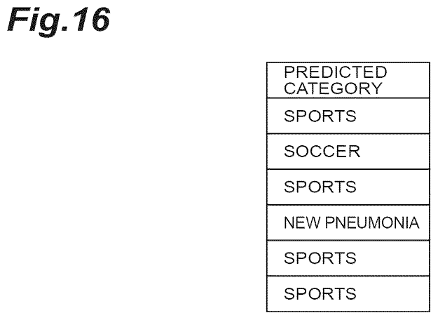

As a result of the inference in S12, the inference unit 12 outputs a category classification result. FIG. 16 is a diagram showing an example of a table of category classification results. In the table example shown in FIG. 16, the first and second records are results of inference with the evaluation data of the group G3, the third and fourth records are results of inference with the evaluation data of the group G2, and the fifth and sixth records are results of inference with the evaluation data of the group G1.

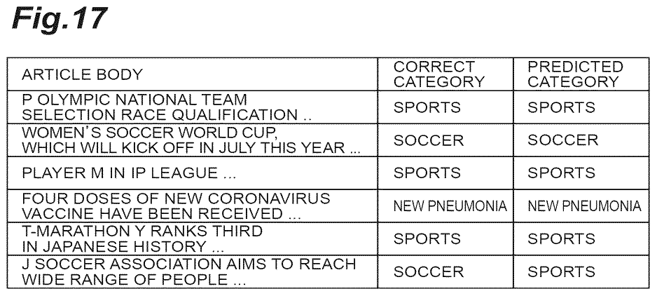

Subsequently, the inference unit 12 vertically combines all inferred category classification results and inputs the table data, which is horizontally combined with the training data, to the misclassification rate calculation unit (step S13). FIG. 17 is a diagram showing an example of another table of table data in which the category classification results are horizontally combined with the training data. In the table example shown in FIG. 17, the table example of training data shown in FIG. 13 is combined with the table example of category classification results shown in FIG. 16.

In the processing of S11 and S12, so-called cross-validation is performed. For example, the training data is classified into K(=5) groups, data of (K−1)(=4) groups is set as learning (training) data and data of one group is set as evaluation (test) data. A learning process is iterated K times so that all groups are evaluation (test) data. The cross-validation is performed to eliminate a possibility that the data used to calculate the misclassification rate (evaluation data) does not include articles (news) in the correct categories “soccer” and “sports” for this training data correction, or that there are extremely few such articles. In other words, the motivation is to prevent the evaluation data from not including the article body corresponding to the upper-lower category pair data. It may be defined that the evaluation data always includes the article body corresponding to the upper-lower category pair data.

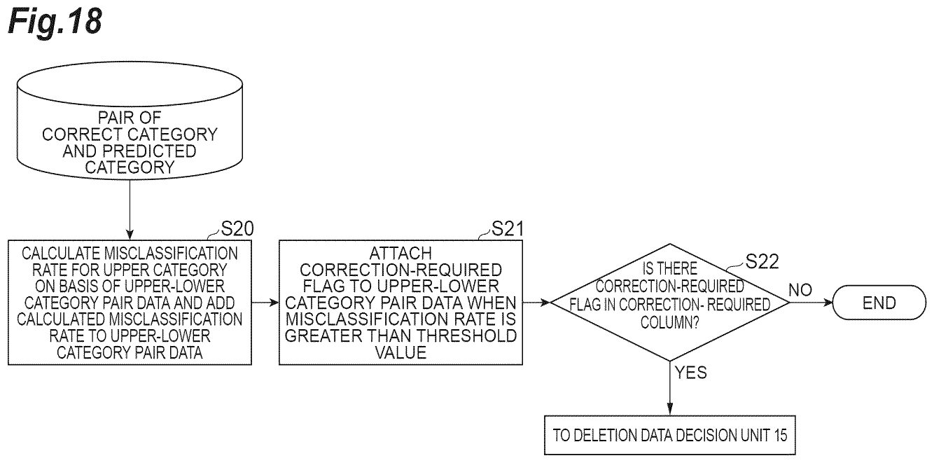

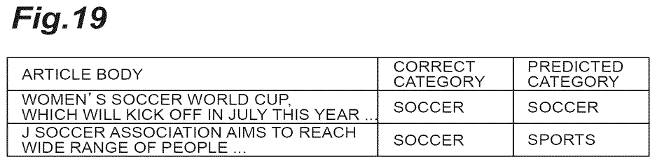

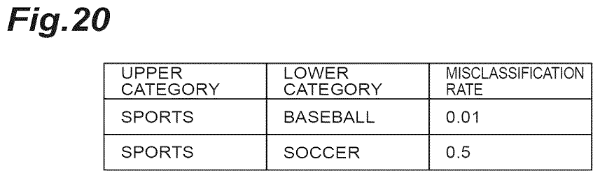

Hereinafter, details of the misclassification rate calculation unit 13 and the training data correction determination unit 14 will be described using the flowchart shown in FIG. 18, the table examples shown in FIGS. 19 and 20, and the like. FIG. 18 is a flowchart showing an example of a process executed by the misclassification rate calculation unit 13 and the training data correction determination unit

After S13, the misclassification rate calculation unit 13 compares correct category/predicted category pairs in the table data obtained by the machine learning unit 11 and the inference unit 12 (table data in which category classification results are horizontally combined with the training data) and calculates a misclassification rate (step S20). Specifically, the misclassification rate calculation unit 13 calculates the misclassification rate for the upper category on the basis of the upper-lower category pair data provided in advance (and stored by the storage unit 10).

More specifically, first, the misclassification rate calculation unit 13 extracts one record (hereafter referred to as one “upper-lower pair”) at a time from the upper-lower category pair data. Subsequently, the misclassification rate calculation unit 13 extracts the records in the table data obtained from the machine learning unit 11 and the inference unit 12 (table data in which the category classification results are horizontally combined with the training data) whose correct category corresponds to the lower category of one upper-lower pair, calculates a ratio at which a predicted category/correct category pair among the extracted records is aligned with one upper-lower pair, and newly adds the ratio to the misclassification rate column in the upper-lower category pair data (step S20). For example, the misclassification rate calculation unit 13 calculates a misclassification rate for the upper category “sports” with respect to the correct category “soccer”. The misclassification rate calculation unit 13 performs the same operation on all upper-lower category pair data.

FIG. 19 is an example of records extracted from the table example in FIG. 17. The table example shown in FIG. 19 extracts a record whose correct category of the table example of FIG. 17 corresponds to the lower category “soccer” in an upper-lower pair.

FIG. 20 is a diagram showing an example of a table in which a misclassification rate column is added to the table example of FIG. 7. In the table example shown in FIG. 20, the misclassification rate calculated in S20 is newly associated with the table example of FIG. 7.

After S20, the misclassification rate calculation unit 13 outputs upper-lower category pair data (see the table example shown in FIG. 9) with a correction-required flag attached to a record higher than a (predetermined) threshold value from the misclassification rate column of the upper-lower category pair data (see the table example shown in FIG. 20) (step S21).

After S21, the training data correction determination unit 14 determines whether or not there is a correction-required flag in the correction-required column (step S22), the transition to the deletion data decision unit 15 is performed when there is a correction-required flag in the correction-required column (step S22: YES), and the process ends when there is no correction-required flag in the correction-required column (step S22: NO).

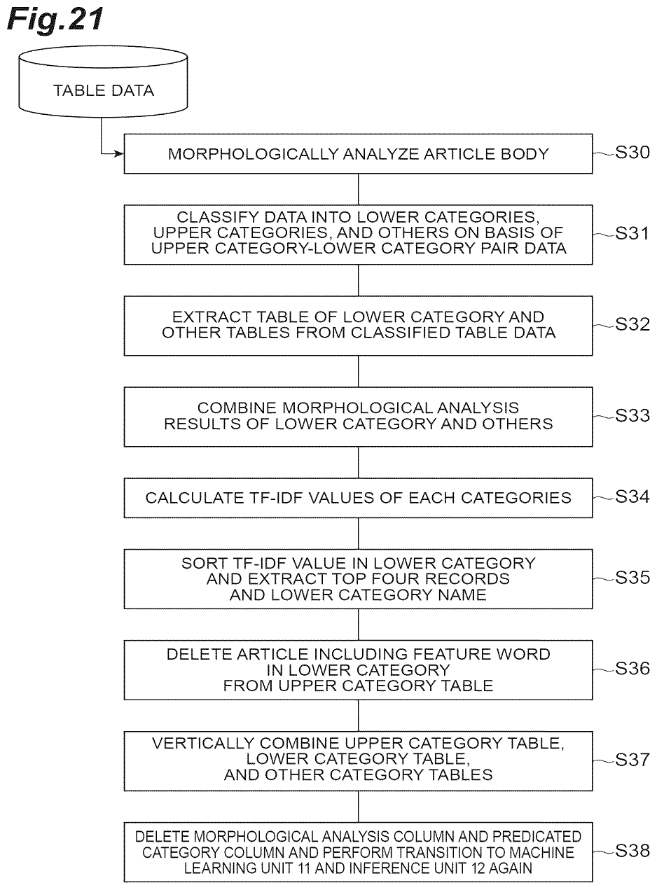

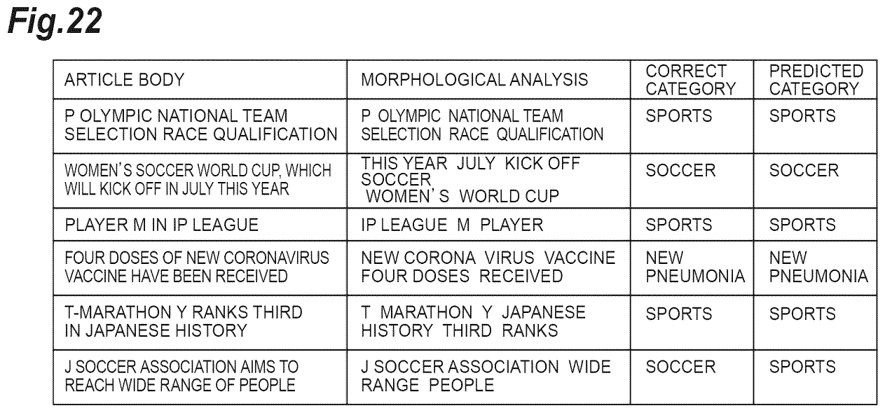

Hereinafter, details of the deletion data decision unit 15 and the training data deletion unit 16 will be described using the flowchart shown in FIG. 21, the table examples shown in FIGS. 22 to 27, and the like. FIG. 21 is a flowchart showing an example of a process executed by the deletion data decision unit 15 and the training data deletion unit 16.

After S22: YES, the deletion data decision unit 15 calculates a feature word in the lower category.

Specifically, first, the deletion data decision unit 15 performs morphological analysis on table data (table data in which category classification results are horizontally combined with training data) obtained from the machine learning unit 11 and the inference unit 12 (step S30). FIG. 22 is a diagram showing an example of a table of morphologically analyzed table data. The table example shown in FIG. 22 is obtained by adding the morphological analysis results of data in the article body column as morphological analysis columns with respect to a table example of table data in which the category classification results shown in FIG. 17 are horizontally combined with the training data.

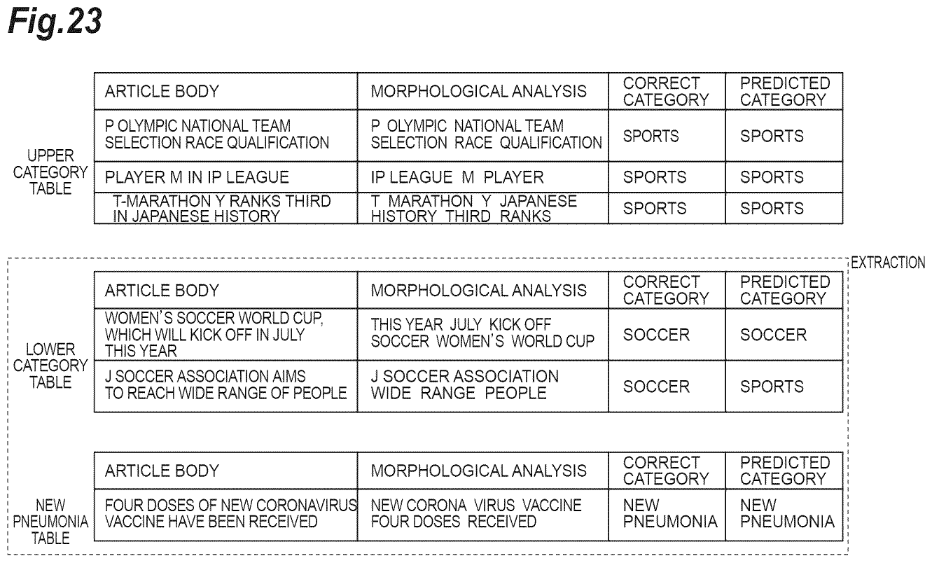

Subsequently, the deletion data decision unit 15 classifies the morphologically analyzed table data according to each correct category (step S31). In addition, the deletion data decision unit 15 may classify the data into lower categories, upper categories, and others on the basis of the upper category-lower category pair data. Subsequently, the deletion data decision unit 15 extracts one record (hereafter referred to as one “correction-required upper-lower pair”) at a time in order from records with the “correction-required” flag on the basis of the upper category-lower category pair data obtained from the misclassification rate calculation unit 13. The deletion data decision unit 15 compares the extracted correction-required upper-lower pair with the classified table data and extracts a table other than the table corresponding to the upper category of the record (step S32). FIG. 23 is a diagram showing an example of classification of the table example of FIG. 22. As shown in the table example shown in FIG. 23, the table example in FIG. 22 is classified into tables for correct categories “sports,” “soccer,” and “new pneumonia” (as an upper category table, a lower category table, and a new pneumonia table, respectively), and the lower category table and the new pneumonia table, which are tables other than the table corresponding to the upper category “sports” of the correction-required upper-lower pair including the upper category “sports” and the lower category “soccer,” are extracted.

After S32, the deletion data decision unit 15 calculates a feature word in the lower category.

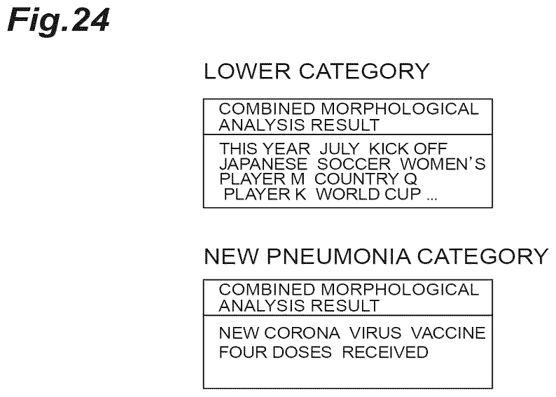

Specifically, first, the deletion data decision unit 15 combines all morphological analysis columns of each category table extracted in S32 (step S33). FIG. 24 is an example of a table of data in which all morphological analysis columns of the table extracted from the table example in FIG. 23 are combined. The table example shown in FIG. 24 includes a table example of data in which all the morphological analysis columns of the lower category table in the table example in FIG. 23 are combined and a table example of data in which all the morphological analysis columns of the new pneumonia category table in the table example in FIG. 23 are combined.

Subsequently, the deletion data decision unit 15 calculates importance (a TFIDF value) of each word within its category on the basis of a TFIDF equation (step S34). An example of the TFIDF equation is shown below (i and j are not in subscript form for convenience, although they are originally in subscript form).

$$T F I D {F}_{w i , d j} = T {F}_{w i , d j} \times I D {F}_{w i}$$

$$T {F}_{w i , d j} = Frequency of occurrence of word wi in document dj$$

$${IDF}_{w i} = log ( ( 1 + Total number of documents ( J ) / ( Number of documents in which word wi appears )$$

In this case, document d denotes a combined morphological analysis result and j denotes each category. In other words, dj denotes a combined morphological analysis result of each category j.

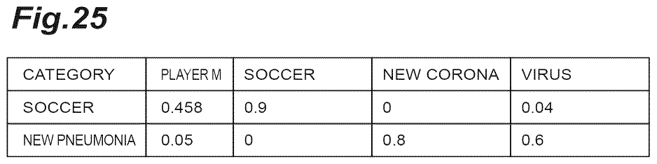

The deletion data decision unit 15 performs the above-described calculation to obtain a feature quantity table. FIG. 25 is a diagram showing an example of a table of a feature quantity table. In the table example shown in FIG. 25, the importance (a TFIDF value) of each word is associated with each category.

Subsequently, the training data deletion unit 16 deletes an article related to the lower category from the upper category.

Specifically, first, the deletion data decision unit 15 extracts records corresponding to the lower category of the correction-required upper-lower pair in the form of a list from the feature quantity table obtained in the previous stage, sorts them in descending order of the TFIDF value, and extracts the top four records (step S35). Subsequently, the training data deletion unit 16 deletes articles of lower categories mixed in the upper category table by keyword matching using all five feature words, including lower category names (step S36).

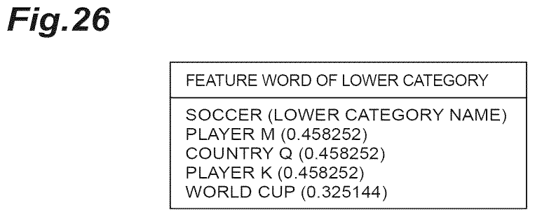

FIG. 26 is a diagram showing an example of another table of data representing feature words and feature quantities of lower categories. The table example shown in FIG. 26 includes a lower category name (“soccer”), the top four words sorted in descending order of the TFIDF value (“player M,” “country Q,” “player k,” and “World Cup”), and the feature words of the lower category, including the feature quantity of each of those words.

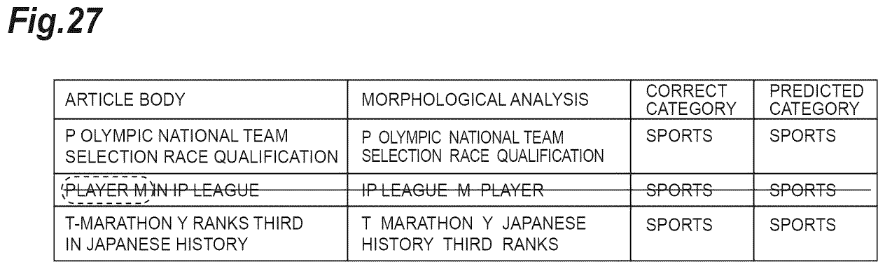

FIG. 27 is a diagram showing an example of deletion of an upper category table. The deletion example shown in FIG. 27 shows that the record of the article body including a word (“player M”) included in the table example of data representing the feature words and feature quantities of the lower categories shown in FIG. 26 has been deleted with respect to the upper category table shown in FIG. 23.

Subsequently, the training data deletion unit 16 vertically combines the upper category table, lower category table, and the tables for other categories corrected in the previous stage (step S37). Subsequently, the training data deletion unit 16 performs these operations on all records with the “correction-required” flag in the upper category-lower category pair data, deletes the morphological analysis column and the prediction category column when all records have been processed, and the transition to the machine learning unit 11 and the inference unit 12 is performed again (step S38). In other words, the training data deletion unit 16 outputs the corrected (formatted) training data (or the corrected (formatted) training data is stored by the storage unit 10).

Other aspects of each functional block will be described below.

The machine learning unit 11 and the inference unit 12 may train a document classification model that classifies the category to which any input document belongs to output the trained document classification model on the basis of the training data deleted by the training data deletion unit 16.

The deletion data decision unit 15 may acquire category information indicating a first category, which is one category, and a second category, which is a category having a hierarchical relationship with the first category and to which a document included in training data that should belong to the first category erroneously belongs or is likely to erroneously belong and identify a feature term in a document that is included in the training data and that belongs to the first category indicated in the acquired category information. The second category may have a higher level of hierarchy than the first category.

The deletion data decision unit 15 may acquire the category information indicating the first category and the second category when the misclassification rate, which is a probability that a document that should belong to the first category will be erroneously classified as belonging to the second category within the document classification model that classifies the category to which any input document belongs and has been trained on the basis of the training data, satisfies a predetermined criterion. Cross-validation is performed in learning based on the training data. The misclassification rate may be the probability that a document that should belong to the first category will be erroneously classified as belonging to the second category.

The training data deletion unit 16 may delete, from the training data, a set of documents including the term identified by the deletion data decision unit 15 among documents included in the training data and belonging to the second category indicated in the category information acquired by the deletion data decision unit 15. The training data deletion unit 16 may delete the training data when a misclassification rate of a document classification model that classifies the category to which any input document belongs and that has been trained on the basis of the training data satisfies the predetermined criterion.

The training data deletion unit 16 may delete, from the training data, a set of documents including the term identified by the deletion data decision unit 15 and the name indicating the first category indicated in the category information among documents included in the training data and belonging to the second category indicated in the category information acquired by the deletion data decision unit 15.

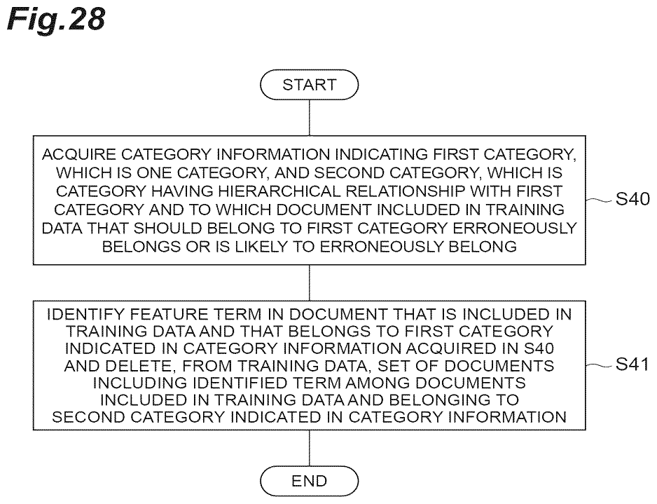

Subsequently, an example of a process executed by the training data correction device 1 will be described with reference to FIG. 28. FIG. 28 is a flowchart showing another example of the process executed by the training data correction device 1.

First, the deletion data decision unit 15 acquires category information (upper-lower category pair data to which a correction-required flag is attached) indicating a first category, which is one category, and a second category, which is a category having a hierarchical relationship with the first category and to which a document included in training data that should belong to the first category erroneously belongs or is likely to erroneously belong (step S40).

Subsequently, the deletion data decision unit 15 identifies a feature term in a document that is included in the training data and that belongs to the first category indicated in the category information acquired in S40 and the training data deletion unit 16 deletes, from the training data, a set of documents including the identified term among documents included in the training data and belonging to a second category indicated in the category information (step S41).

Subsequently, functions and effects of the training data correction device 1 according to the present embodiment will be described.

The training data correction device 1 is a training data correction device 1 for correcting training data including sets of categories with a hierarchical structure and documents belonging to the categories, the training data correction device comprising: a deletion data decision unit 15 configured to acquire category information indicating a first category, which is one category, and a second category, which is a category having a hierarchical relationship with the first category and to which a document included in training data that should belong to the first category erroneously belongs or is likely to erroneously belong and identify a feature term in a document that is included in the training data and that belongs to the first category indicated in the acquired category information; and a training data deletion unit 16 configured to delete, from the training data, a set of documents including the term identified by the deletion data decision unit 15 among documents included in the training data and belonging to a second category indicated in the category information acquired by the deletion data decision unit 15. According to this configuration, a set of documents including a feature term in the documents belonging to the first category among documents belonging to the second category (which is a category in a hierarchical relationship with the first category) included in the training data including sets of categories with a hierarchical structure and documents belonging to the categories is deleted from the training data. In other words, training data including a set of categories with a hierarchical structure and documents belonging to the categories can be corrected.

Moreover, the hierarchical structure of categories may change over time in the training data correction device 1. According to this configuration, it is possible to more appropriately correct the training data in accordance with the hierarchical structure after the change even if time elapses.

Moreover, in the training data correction device 1, the second category may have a higher level of hierarchy than the first category. According to this configuration, it is possible to appropriately delete the document even if a document of the first category having a lower level belongs to the second category having a higher level in the training data.

Moreover, in the training data correction device 1, (the deletion data decision unit 15 and) the training data deletion unit 16 may delete the training data when a misclassification rate of a document classification model that classifies the category to which any input document belongs and that has been trained on the basis of the training data satisfies the predetermined criterion. According to this configuration, it is possible to more reliably correct training data when there are deficiencies in the training data.

Moreover, in the training data correction device 1, cross-validation may be performed in learning based on the training data. According to this configuration, it is possible to eliminate the possibility that the evaluation data used to calculate the misclassification rate does not include documents to be corrected in the training data or that there are extremely few of them.

Moreover, in the training data correction device 1, the misclassification rate may be a probability that a document that should belong to the first category is erroneously classified as belonging to the second category. According to this configuration, it is possible to more reliably correct training data in which a document that should belong to the first category erroneously belongs to the second category.

Moreover, in the training data correction device 1, the deletion data decision unit 15 may acquire the category information indicating the first category and the second category when the misclassification rate, which is a probability that a document that should belong to the first category will be erroneously classified as belonging to the second category within the document classification model that classifies the category to which any input document belongs and has been trained on the basis of the training data, satisfies the predetermined criterion. According to this configuration, it is possible to more reliably correct training data when there are deficiencies in the training data.

Moreover, in the training data correction device 1, the deletion data decision unit 15 may identify a feature term in a document included in the training data and belonging to the first category indicated in the acquired category information, and the training data deletion unit 16 may delete, from the training data, a set of documents including the term identified by the deletion data decision unit 15 and the name indicating the first category among documents included in the training data and belonging to a second category indicated in the category information acquired by the deletion data decision unit 15. According to this configuration, because the sets of documents including names indicating the first category are also deleted from the training data, the training data can be corrected more accurately.

Moreover, the training data correction device 1 may further include the machine learning unit 11 configured to train and output a document classification model that classifies the category to which any input document belongs, on the basis of the training data deleted by the training data deletion unit 16. According to this configuration, it is possible to increase the accuracy of the document classification model.

The training data correction device 1 relates to the automation of formatting of training data. After a learning process using inaccurate learning data with a mixture of old and new categories, the training data correction device 1 calculates a misclassification rate for an upper category, identifies upper-lower categories that need to be corrected in the training data according to the calculated misclassification rate, identifies a feature word in the lower category, and deletes a document related to the lower category from past training data, such that the training data is cost-effectively and quickly corrected and the accuracy of the model is improved.

According to the training data correction device 1, the effect from the user's perspective is that articles are correctly classified into lower categories and a state in which articles are scattered in both upper and lower categories can be eliminated. Moreover, as an effect from the operator's perspective, data formatting is easily implemented even if a certain category is newly added.

The training data correction device 1 of the present disclosure may include the following configurations.
[A] A training data correction device for deleting training data of a lower category mixed with training data of an upper category, the training data correction device comprising:
a machine learning and inference unit configured to train a document classification model using training data, input text data constituting the training data to the trained document classification model, and output a category classification result;
a misclassification rate calculation unit configured to compare the output category classification result with the categories previously assigned to the training data and calculate a misclassification rate for the upper category on the basis of upper-lower category pair data;
a training data correction determination unit configured to determine whether or not to correct the training data according to whether or not the misclassification rate for the upper category is greater than a threshold value; and
a training data correction unit configured to correct the training data by deleting the training data of the lower category mixed with the training data of the upper category using a feature word representing the lower category.
[B] The training data correction device according to [A], further comprising a deletion data decision unit configured to extract the feature word representing the lower category,
wherein the training data correction unit corrects the training data using feature words and category names obtained using the deletion data decision unit.

The training data correction device 1 of the present disclosure may include the following configurations.
[1] A training data correction device for correcting training data including sets of categories with a hierarchical structure and documents belonging to the categories, the training data correction device comprising:
an acquisition unit configured to acquire category information indicating a first category, which is one category, and a second category, which is a category having a hierarchical relationship with the first category and to which a document included in training data that should belong to the first category erroneously belongs or is likely to erroneously belong; and
a deletion unit configured to identify a feature term in a document that is included in the training data and that belongs to the first category indicated in the category information acquired by the acquisition unit and delete, from the training data, a set of documents including the identified term among documents included in the training data and belonging to a second category indicated in the category information.
[2] The training data correction device according to [1], wherein the hierarchical structure of the categories changes over time.
[3] The training data correction device according to [1] or [2], wherein the second category is hierarchically higher than the first category.
[4] The training data correction device according to any one of [1] to [3], wherein the deletion unit deletes the training data when a misclassification rate of a document classification model that classifies the category to which any input document belongs and that has been trained on the basis of the training data satisfies a predetermined criterion.
[5] The training data correction device according to [4], wherein cross-validation is performed in learning based on the training data.
[6] The training data correction device according to [4] or [5], wherein the misclassification rate is a probability that a document that should belong to the first category is erroneously classified as belonging to the second category.
[7] The training data correction device according to any one of [1] to [6], wherein the acquisition unit acquires the category information indicating the first category and the second category when the misclassification rate, which is a probability that a document that should belong to the first category will be erroneously classified as belonging to the second category within the document classification model that classifies the category to which any input document belongs and has been trained on the basis of the training data, satisfies the predetermined criterion.
[8] The training data correction device according to any one of [1] to [7], wherein the deletion unit identifies a feature term in a document included in the training data and belonging to the first category indicated in the category information acquired by the acquisition unit and deletes, from the training data, a set of documents including the identified term and a name indicating the first category among documents included in the training data and belonging to the second category indicated in the category information.
[9] The training data correction device according to any one of [1] to [8], further including a learning unit configured to train and output a document classification model that classifies the category to which any input document belongs, on the basis of the training data deleted by the deletion unit.

In the block diagrams with reference to which the embodiment has been described, blocks of functional units are illustrated. Such functional blocks (constituent units) are implemented by an arbitrary combination of at least one of hardware and software. In addition, a method for implementing each functional block is not particularly limited. In other words, each functional block may be implemented by using one device that is combined physically or logically or using a plurality of devices by directly or indirectly (for example, using a wire or wirelessly) connecting two or more devices separated physically or logically. A functional block may be implemented by one device or a plurality of devices described above and software in combination.

The functions include determining, deciding, determination, calculating, computing, processing, deriving, investigating, searching, ascertaining, receiving, transmitting, outputting, accessing, resolving, selecting, choosing, establishing, comparing, supposing, expecting, considering, broadcasting, notifying, communicating, forwarding, configuring, reconfiguring, allocating or mapping, and assigning, but are not limited thereto. For example, a functional block (constituent unit) enabling transmission to function is referred to as a transmitting unit or a transmitter. In either case, as described above, implementation methods are not particularly limited.

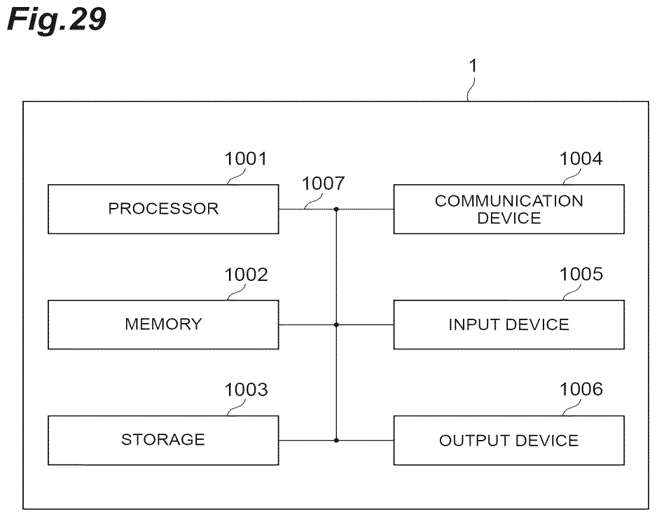

For example, the training data correction device 1 in the embodiment of the present disclosure may function as a computer that performs a process of the training data correction method of the present disclosure. FIG. 29 is a diagram showing an example of a hardware configuration of a training data correction device 1 according to the embodiment of the present disclosure. The above-described training data correction device 1 may be physically configured as a computer device including a processor 1001, a memory 1002, a storage 1003, a communication device 1004, an input device 1005, an output device 1006, a bus 1007, and the like.

In addition, in the following description, a term “device” may be rephrased as a circuit, a device, a unit, or the like. The hardware configuration of the training data correction device 1 may be configured to include one or more of respective devices shown in the drawing, or may be configured not to include some of the devices.

The processor 1001 performs an arithmetic operation by reading predetermined software (a program) onto hardware such as the processor 1001 or the memory 1002, and thus each function of the training data correction device 1 is implemented by controlling communication in the communication device 1004 or controlling at least one of reading-out and writing of data in the memory 1002 and the storage 1003.

The processor 1001, for example, controls the entire computer by operating an operating system. The processor 1001 may be configured as a central processing unit (CPU) including an interface with peripherals, a control device, an arithmetic operation unit, and a register. For example, the machine learning unit 11, the inference unit 12, the misclassification rate calculation unit 13, the training data correction determination unit 14, the deletion data decision unit 15, the training data deletion unit 16, and the like described above may be implemented by the processor 1001.

Moreover, the processor 1001 reads a program (a program code), a software module, data, or the like from the storage 1003 and/or the communication device 1004 to the memory 1002 and performs various types of processes in accordance therewith. As the program, a program that causes a computer to perform at least some of the operations described above in the embodiment is used. For example, the machine learning unit 11, the inference unit 12, the misclassification rate calculation unit 13, the training data correction determination unit 14, the deletion data decision unit 15, and the training data deletion unit 16 may be implemented by a control program stored in the memory 1002 and operating in the processor 1001 and may be implemented similarly for other functional blocks. While the various types of processes described above have been described as being executed by one processor 1001, they may be executed simultaneously or sequentially by two or more processors 1001. The processor 1001 may be mounted as one or more chips. Also, the program may be transmitted from the network via a telecommunications circuit.

The memory 1002 is a computer-readable recording medium, and may include, for example, at least one of a read only memory (ROM), an erasable programmable ROM (EPROM), an electrically erasable programmable ROM (EEPROM), and a random-access memory (RAM). The memory 1002 may also be referred to as a register, a cache, a main memory (a main storage device), or the like. The memory 1002 is capable of storing programs (program codes), software modules, and the like capable of being executed to perform a wireless communication method according to an embodiment of the present disclosure.

The storage 1003 is a computer-readable storage medium. The storage 1003 may include, for example, at least one of an optical disc, such as a compact disc ROM (CD-ROM), a hard disk drive, a flexible disk; an optical magnetic disk (e.g., a compact disc, a digital versatile disc, or a Blu-ray (registered trademark) disc), a smart card; a flash memory (e.g., a card, a stick, or a key drive), a floppy (registered trademark) disk, a magnetic strip, or the like. The storage 1003 may be referred to as an auxiliary memory device. The above-described storage medium may be, for example, a database including at least one of the memory 1002 and the storage 1003, a server, or another suitable medium.

The communication device 1004 is hardware (a transceiver device) for performing communication between computers via at least one of a wired network and a wireless network. The communication device 1004 is also referred to, for example, as a network device, a network control unit, a network card, a communication module, or the like. The communication device 1004 may be configured to include a high-frequency switch, a duplexer, a filter, a frequency synthesizer, or the like to implement, for example, at least one of frequency division duplex (FDD) and time division duplex (TDD). For example, the machine learning unit 11, the inference unit 12, the misclassification rate calculation unit 13, the training data correction determination unit 14, the deletion data decision unit 15, and the training data deletion unit 16 described above may be implemented by the communication device 1004.

The input device 1005 is an input device (e.g., a keyboard, a mouse, a microphone, a switch, a button, a sensor, or the like) that receives an external input. The output device 1006 is an output device (e.g., a display, a speaker, an LED lamp, or the like) that externally provides an output. Also, the input device 1005 and the output device 1006 may have an integrated configuration (e.g., a touch panel).

Moreover, the devices such as the processor 1001 and the memory 1002 are connected to each other via the bus 1007 for communication of information. The bus 1007 may be configured using a single bus, or may be configured using different buses between devices.

Moreover, the training data correction device 1 may be configured to include hardware such as a microprocessor, a digital signal processor (DSP), an application-specific integrated circuit (ASIC), a programmable logic device (PLD), and a field programmable gate array (FPGA), and some or all functional blocks may be implemented by the hardware. For example, the processor 1001 may be implemented by at least one of the above-described pieces of hardware.

An information notification is not limited to an aspect/embodiment described in the present disclosure and may be provided using other methods.

Each of the above aspects/embodiments may be applied to at least one of long term evolution (LTE), LTE-advanced (LTE-A), SUPER 3G, IMT-Advanced, 4th generation mobile communication system (4G), 5th generation mobile communication system (5G), future radio access (FRA), new radio (NR), W-CDMA (Registered Trademark), GSM (Registered Trademark), CDMA2000, ultra mobile broadband (UMB), IEEE 802.11 (Wi-Fi (Registered Trademark)), IEEE 802.16 (WiMAX (Registered Trademark)), IEEE 802.20, ultra-wideband (UWB), Bluetooth (Registered Trademark), a system using any other appropriate system, and a next-generation system that is expanded based thereon. Moreover, a combination of a plurality of systems (e.g., a combination of at least one of the LTE and the LTE-A with the 5G or the like) may be applied.

The processing procedure, sequence, flowchart, and the like of the aspects/embodiments described in the present disclosure may be performed in a different order as long as no contradiction is incurred. For example, for a method described in the present disclosure, elements of various steps are described in illustrative order, and the order is not limited to the described specific order.

Input or output information and the like may be stored in a predetermined location (e.g., a memory) or may be managed using a management table. Input or output information and the like can be overwritten or updated, or information may be added thereto. Output information and the like may be deleted. Input information and the like may be transmitted to another device.

Determination may be made by a value represented by one bit (0 or 1), may be made by a Boolean value (Boolean: true or false), or may be made by comparison of numerical values (e.g., comparison with a predetermined value).

Each aspect/embodiment described in the present disclosure may be used alone; may be combined to be used; or may be switched in accordance with execution. Furthermore, the notification of predetermined information (e.g., the notification indicating that “it is X”) is not limited to the notification that is made explicitly; and the notification may be made implicitly (e.g., the notification of the predetermined information is not performed).

Although the present disclosure has been described in detail above, it is clear to those skilled in the art that the present disclosure is not limited to the embodiments described in the present disclosure. The present disclosure can be practiced with modifications and variations without departing from the spirit and scope of the present disclosure as defined by the claims. Accordingly, the description of the present disclosure is for illustrative purposes and is not meant to be limiting in any way.

Regardless of whether software is referred to as software, firmware, middleware, microcode, hardware description language, or another name, the software should be interpreted broadly so as to imply a command, a command set, a code, a code segment, a program code, a program, a subprogram, a software module, an application, a software application, a software package, a routine, a subroutine, an object, an executable file, an execution thread, a procedure, a function, and the like.

Moreover, software, a command, information, and the like may be transmitted and received via a transmission medium. For example, when the software is transmitted from a Web site, a server, or another remote source using at least one of wired technology (such as a coaxial cable, an optical fiber cable, a twisted pair, and a digital subscriber line (DSL)) and wireless technology (such as infrared, microwave, and the like), at least one of the wired technology and wireless technology is included within the definition of the transmission medium.

Information, signals, or the like described in the present disclosure may be represented by using any of a variety of different technologies. For example, data, an instruction, a command, information, a signal, a bit, a symbol, a chip, or the like that may be described throughout the above description may be represented by a voltage, a current, electromagnetic waves, a magnetic field, a magnetic particle, an optical field, photons, or a desired combination thereof.

The terms described in the present disclosure and terms necessary for understanding the present disclosure may be replaced by terms having the same or similar meanings.

The terms “system” and “network” used in the present disclosure are used interchangeably.

Also, the information, parameters, and the like, which are described in the present disclosure, may be represented by absolute values, may be represented as relative values from predetermined values, or may be represented by any other corresponding information.

The name used for the above parameter is not restrictive in any respect. Furthermore, formulas and the like using these parameters may be different from those explicitly disclosed in the present disclosure.

Terms such as “determining” and “deciding” used in the present disclosure may include various operations of various types. The terms “determining” and “deciding” used in the present disclosure may include various types of operations. For example, “determining” and “deciding” may include deeming that a result of judging, calculating, computing, processing, deriving, investigating, looking up, search, and inquiry (e.g., search in a table, a database, or another data structure), or ascertaining is determined or decided. Moreover, “determining” and “deciding” may include, for example, deeming that a result of receiving (e.g., reception of information), transmitting (e.g., transmission of information), input, output, or accessing (e.g., accessing data in memory) is determined or decided. Moreover, “determining” and “deciding” may include deeming that a result of resolving, selecting, choosing, establishing, or comparing is determined or decided. Moreover, “determining” and “deciding” may include deeming that some operation is determined or decided. Moreover, “determining (deciding)” may be read as “assuming,” “expecting,” “considering,” or the like.

The terms “connected,” “coupled,” or any variation thereof, mean any direct or indirect connection or coupling between two or more elements and can include the presence of one or more intermediate elements between two elements being “connected” or “coupled.” Couplings or connections between elements may be physical, logical, or a combination thereof. For example, “connection” may be read as “access.” As used in the present disclosure, two elements are defined to be “connected” or “coupled” to each other using at least one of one or more wires, cables, and printed electrical connections and, as some non-limiting and non-exhaustive examples, in the radio frequency domain, electromagnetic energy having wavelengths in the microwave and optical (both visible and invisible) regions, and the like.

The expression “on the basis of” used in the present specification does not mean “on the basis of only” unless otherwise stated particularly. In other words, the expression “on the basis of” means both “on the basis of only” and “on the basis of at least.”

Any reference to elements using names, such as “first” and “second,” which are used in the present disclosure, does not generally limit the quantity or order of these elements. These names can be used in the present disclosure as a convenient method for distinguishing two or more elements. Accordingly, the reference to the first and second elements does not imply that only the two elements can be adopted here, or does not imply that the first element must precede the second element in any way.

The term “means” in the configuration of each device described above may be replaced with a term such as “unit,” “circuit,” or “device.” As long as “include,” “including,” and the variations thereof are

used in the present disclosure, these terms are intended to be inclusive, similar to the term “comprising.” Furthermore, it is intended that the term “or” used in the present disclosure is not “exclusive OR.”

In the present disclosure, for example, if articles, such as a, an, and the in English, are added according to translation, the present disclosure may include that the nouns following these articles have plural forms.

In the present disclosure, the term “A and B are different” may mean “A and B are different from each other.” The term may also mean that “A and B are different from C.” The terms such as “separate,” “coupled,” and the like may also be interpreted like the term “different.”

### REFERENCE SIGNS LIST

1 . . . Training data correction device, 10 . . . Storage unit, 11 . . . Machine learning unit, 12 . . . Inference unit, 13 . . . Misclassification rate calculation unit, 14 . . . Training data correction determination unit, 15 . . . Deletion data decision unit, 16 . . . Training data deletion unit, 1001 Processor, 1002 . . . Memory, 1003 . . . Storage, 1004 . . . Communication device, 1005 . . . Input device, 1006 . . . Output device, 1007 . . . Bus.

1. A training data correction device for correcting training data including sets of categories with a hierarchical structure and documents belonging to the categories, the training data correction device comprising processing circuitry configured to:
acquire category information indicating a first category, which is one category, and a second category, which is a category having a hierarchical relationship with the first category and to which a document included in training data that should belong to the first category erroneously belongs or is likely to erroneously belong; and
identify a feature term in a document that is included in the training data and that belongs to the first category indicated in the acquired category information and delete, from the training data, a set of documents including the identified term among documents included in the training data and belonging to a second category indicated in the category information.

2. The training data correction device according to claim 1, wherein the hierarchical structure of the categories changes over time.

3. The training data correction device according to claim 1, wherein the second category is hierarchically higher than the first category.

4. The training data correction device according to claim 1, wherein processing circuitry is configured to delete the training data when a misclassification rate of a document classification model that classifies the category to which any input document belongs and that has been trained on the basis of the training data satisfies a predetermined criterion.

5. The training data correction device according to claim 4, wherein cross-validation is performed in learning based on the training data.

6. The training data correction device according to claim 4, wherein the misclassification rate is a probability that a document that should belong to the first category is erroneously classified as belonging to the second category.

7. The training data correction device according to claim 1, wherein the processing circuitry is configured to acquire the category information indicating the first category and the second category when a misclassification rate, which is a probability that a document that should belong to the first category will be erroneously classified as belonging to the second category within a document classification model that classifies the category to which any input document belongs and has been trained on the basis of the training data, satisfies the predetermined criterion.

8. The training data correction device according to claim 1, wherein the processing circuitry is configured to identify a feature term in a document included in the training data and belonging to the first category indicated in the acquired category information and to delete, from the training data, a set of documents including the identified term and a name indicating the first category among documents included in the training data and belonging to the second category indicated in the category information.

9. The training data correction device according to claim 1, wherein the processing circuitry is further configured to train and output a document classification model that classifies the category to which any input document belongs, on the basis of the deleted training data.
